(19) United States
(12) Patent Application Publication
(10) Pub. No.: US 2018/0104801 A1
(43) Pub. Date: Apr. 19, 2018

(54) TORQUE-LIMITING DRIVER WITH EMBODIED ROLLER

(71) Applicant: Bradshaw Medical, Inc., Kenosha, WI (US)

(72) Inventors: MARK BAKULA, Racine, WI (US); Tomas Fandel, Milwaukee, WI (US); Christopher J. Melnick, Milwaukee, WI (US)

(73) Assignee: Bradshaw Medical, Inc., Kenosha, WI (US)

(21) Appl. No.: 15/730,145

(22) Filed: Oct. 11, 2017

Related U.S. Application Data
(60) Provisional application No. 62/408,966, filed on Oct. 17, 2016.

(51) Int. Cl. B25B 23/142; B25B 23/14

(52) U.S. Cl. CPC B25B 23/1427; B25B 23/16; B25B 23/141

(57) ABSTRACT

A torque-limiting driver with a drive element configured to have a rounded protruding feature that comprises an embodied roller which maintains contact with a cam element under a preload by a biasing member and contained within a handle housing. When a predetermined torque value is reached, which exceeds the preload by the biasing member, the drive element moves about the surface profile of the cam element and linearly within the handle housing, preventing torque above the predetermined torque value from being delivered to the shaft assembly from the handle housing.

### RELATED APPLICATIONS

This application claims the benefit of co-pending U.S. Provisional Patent Application No. 62/408,966, filed 17 Oct. 2016.

### BACKGROUND OF THE INVENTION

The present invention relates to drivers and devices for delivering limited amounts of torque upon an object and, more particularly, to the specific use of an embodied roller to achieve the torque limiting function.

Screwdrivers, wrenches, and other tools have been developed to allow for a pre-determined amount of torque to be delivered upon an object. These devices allow for a range of pre-set torques to be built into a torque-limiting device. In certain devices and drivers, such as devices used in the medical field, these devices must be able to exert a large amount of torque, while retaining a high level of precision.

Generally, prior art drivers use a rolling member such as rollers, roller bearings, balls, or ball bearings placed between two clutch elements or between a cam element and a drive element. As the clutch elements rotate relative to one another, the rolling member rolls within a grooved slot formed by the drive element and along a surface profile of the cam element, with the surface profile having varying depths. As a user increases the applied torque on the driver, the rolling member is forced to roll along the surface profile of the cam element. When the torque reaches a specified setting, the rolling member is forced into an area of the surface profile that prevents the two elements from transfer of load between one another, thus preventing any further torque from being delivered to the driven object.

While able to limit the amount of torque being delivered, the drivers can be subjected to a significant amount of use, e.g. a significant amount of stress, especially on the rolling members themselves. When these devices trigger a torque limiting function or maximum torque level, the drive and cam elements sandwich the rolling member, exerting a large amount of pressure on the rolling member. This smashing action of the rolling member can deteriorate and, in some cases, fully inhibit the rolling action of the rolling member, which results in the effectiveness of the driver being diminished and the amount of torque being delivered to be inconsistent. This is not desirous for equipment requiring a high-level of precision, especially when the equipment is used in a medical setting.

Thus, it would be advantageous to have a wrench or driver that is capable of delivering torque at a high level of precision consistently over many successive procedures without the concern of the rolling member being inhibited from rolling.

### SUMMARY OF THE INVENTION

The present invention comprises a torque-limiting system for a tool that features a drive element and cam element positioned within a housing, with a drive element which has a rolling member embodied into the cam element. The rolling member is an extension or a projection of the cam element, essentially having the rolling member embodied in the cam element. The drive element is movable with respect to and within the handle housing as it follows the surface profile of the cam element. The drive element is subjected to a biasing force or pre-loaded force to maintain constant direct contact with the cam element by a biasing mechanism. When a pre-determined torque value is reached, which exceeds the biasing force, the drive element moves about the cam element and linearly within the handle housing, into an area of the cam element surface profile that prevents excess torque from being delivered to the driven object from the handle housing.

### BRIEF DESCRIPTION OF THE DRAWINGS

FIG. 1 is a perspective view of a prior art variable torque-limiting driver.

FIG. 2 is a cross-sectional view of the prior art driver of FIG. 1 taken along the line 2-2 of FIG. 1.

FIG. 3 is a cross-sectional view of the prior art driver of FIG. 1 taken along the line 3-3 of FIG. 2.

FIG. 4 is a close-up view of the area included in the circle in FIG. 3, detailing the prior art free gap arrangement.

FIG. 4A is another close-up view of depicting the prior art free gap arrangement as discussed with respect to FIG. 4.

FIG. 5 is a perspective view of a first embodiment of a torque-limiting driver assembly according to the present invention.

FIG. 6 is a cross-sectional view of the first embodiment driver in FIG. 5 along line 6-6 of FIG. 5.

FIG. 7 is a cross-sectional view of the first embodiment driver in FIG. 5 along line 7-7 of FIG. 5.

FIG. 8 is an exploded view of the first embodiment driver of FIG. 5.

FIG. 8A is a close-up exploded view of the drive element and cam element of the embodiment shown in FIG. 5.

FIG. 8B demonstrates the drive element and cam element shown in FIG. 8A interacting with one another.

FIG. 9 is a perspective view of a second embodiment of a torque-limiting driver assembly according to the present invention.

FIG. 10 is a cross-sectional view of the second embodiment driver in FIG. 9 along line 10-10 of FIG. 9.

FIG. 11 demonstrates the drive element and cam element shown in FIG. 11 interacting with one another.

FIG. 12 is a side-elevation view of a drive element and a cam element of the second embodiment driver according to the present invention.

FIG. 13 is an exploded view of the second embodiment driver of FIG. 9.

FIG. 14 is a perspective view of a third embodiment of a torque-limiting driver assembly according to the present invention.

FIG. 15 is a cross-sectional view of the third embodiment driver in FIG. 14 along line 15-15 of FIG. 14.

FIG. 16 is a perspective view of a drive element and a cam element of the third embodiment of the driver according to the present invention.

FIG. 17 demonstrates the drive element and cam element shown in FIG. 16 interacting with one another.

FIG. 18 is an exploded view of the third embodiment driver of FIG. 14.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

U.S. Pat. No. 7,389,700 provides a variable torque-limiting driver. It is described below with respect to the prior art figures and is herein incorporated by reference.

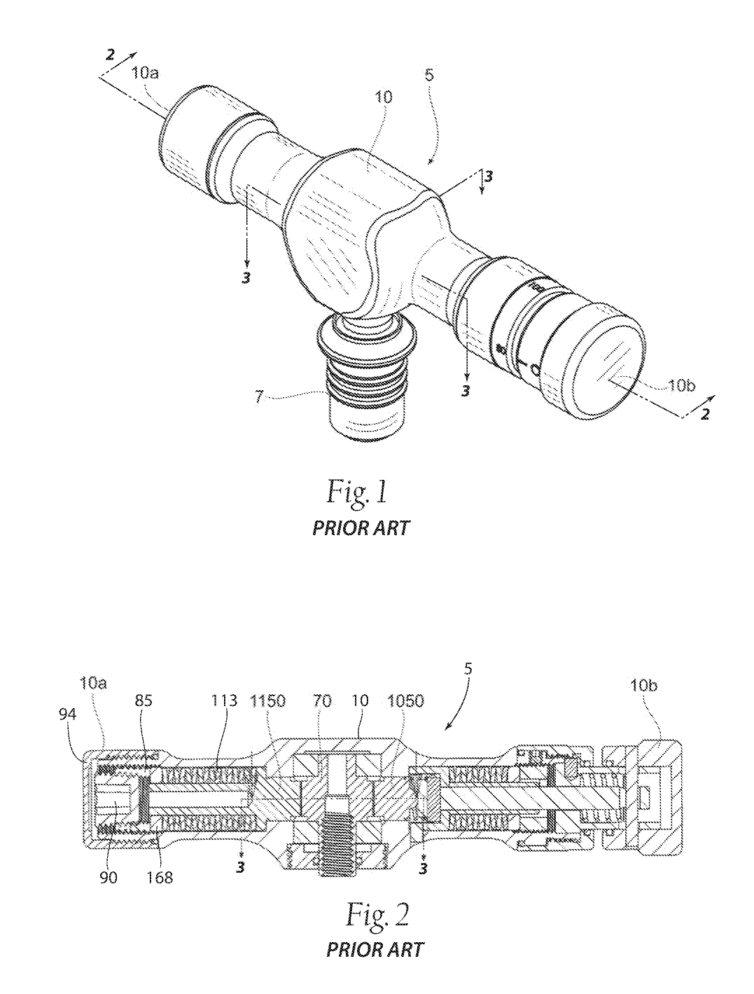

FIGS. 1-4 illustrate a prior art adjustable torque-limiting driver 5 comprising a handle 10 with first end 10a and a second end 10b, a cam element 70, and a driver or an adaptor 7. Looking specifically to the first end 10a, there is a plunger 1150, and a roller 1141. The plunger 1150 is generally in an interacting relationship with the cam element 70 through the roller 1141, which is integral with the plunger 1150.

Shown in FIG. 2, the plunger 1150 sits within the first end 10a with a spring 113 surrounding the plunger 1150 and providing compression force for the plunger 1150 to interact with cam member 70. A spacer 168 sits between the spring 113 and a locking screw 85. These elements are held in place within the first end 10a by a plug 90, which also keeps the plunger 1150 properly positioned within the handle 10 and ensures the plunger 1150 provides consistent and accurate force as it contacts the cam member 70 with each torque actuation.

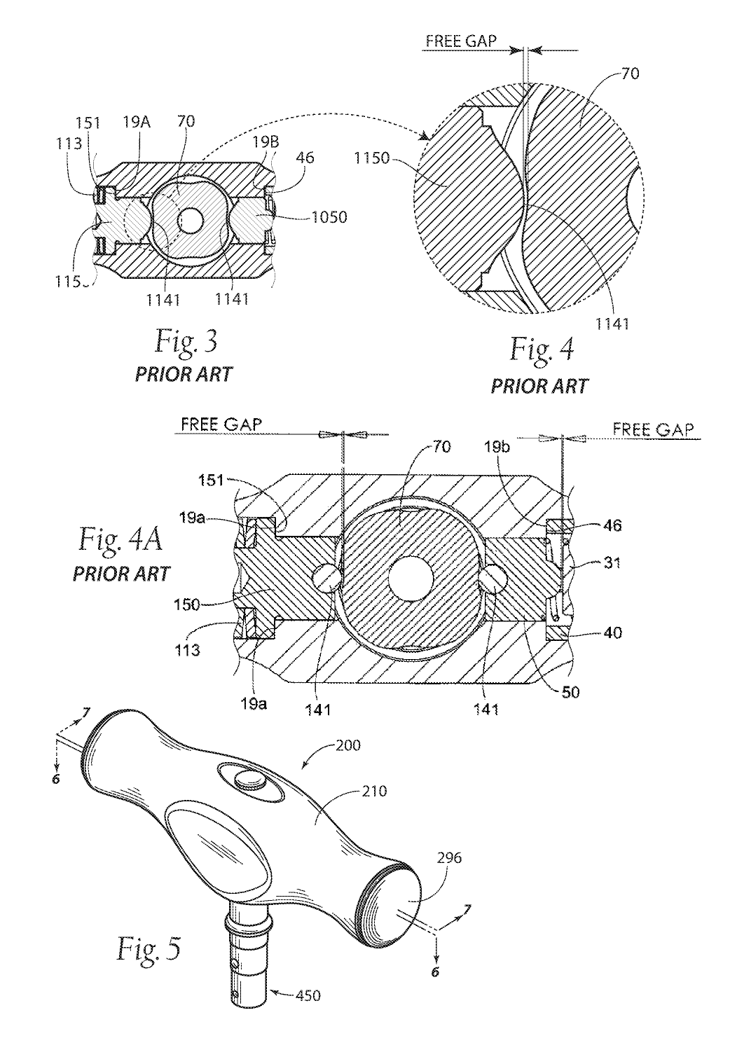

Referring to the prior art FIGS. 4 and 4A, a “free gap” is shown between the roller 1141 (FIG. 4) or the roller 141 (FIG. 4A) and the cam member 70 when the driver 5 is not in use. An engaged position occurs when the roller 1141 on the plunger 1150 (FIG. 4) or the roller 141 and the plunger 150 (FIG. 4A) makes direct contact with the cam member 70 when the driver 5 is rotated and torque is applied to the adaptor 7. The free gap is provided by the biased arrangement of the plunger 1150 (or 150) against a face 19a (see FIG. 3). The free gap is described as an important feature of the prior art invention because the free gap prevents the plunger 1150 or 150 from being subjected to a large amount of impact force when the driver 5 is subjected to a maximum amount of torque and returned to the resting position. The present invention does not utilize this free gap as well as not utilizing a rolling member and thus is sufficiently different from the prior art to drive the present invention.

FIGS. 5-8 illustrate a first embodiment 200 of a torque-limiting driver assembly according to the present invention. The driver 200 preferably comprises a housing 210, at least one torque-limiting assembly with a drive component (as shown here preferably having a first torque-limiting assembly 250 with drive component 258 and a second torque-limiting assembly 350 with drive component 358), and a driven assembly 400.

The housing 210 preferably comprises a first end portion 212, a second end portion 228 opposite the first end portion 212, and a medial portion 224 located between the first and second end portions 212,228.

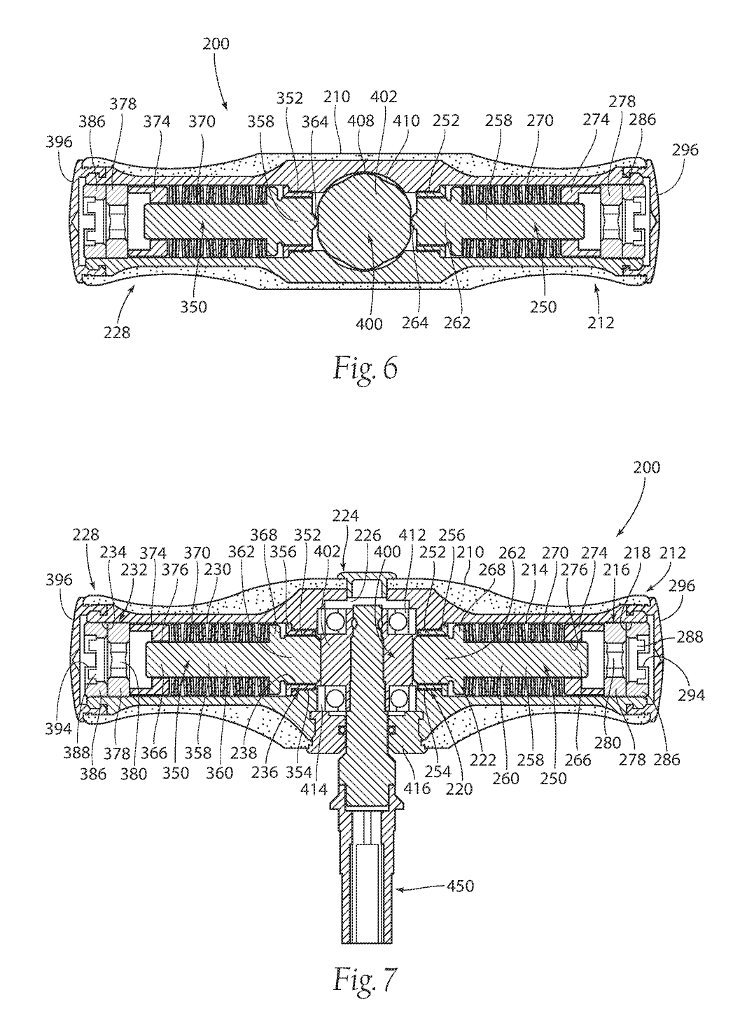

Looking to FIGS. 6 and 7, the first end portion 212 comprises a first end portion channel 214, the second end portion 228 comprises a second end portion channel 230, and the medial portion 224 comprises a medial portion channel 226. The distal portions 216,232 of the first and second end portion channels 214,230 have internal threads 218,234, respectively. Similarly, the proximal portions 220,236 of the first and second end portion channels 214,230 have internal threads 222,238, respectively.

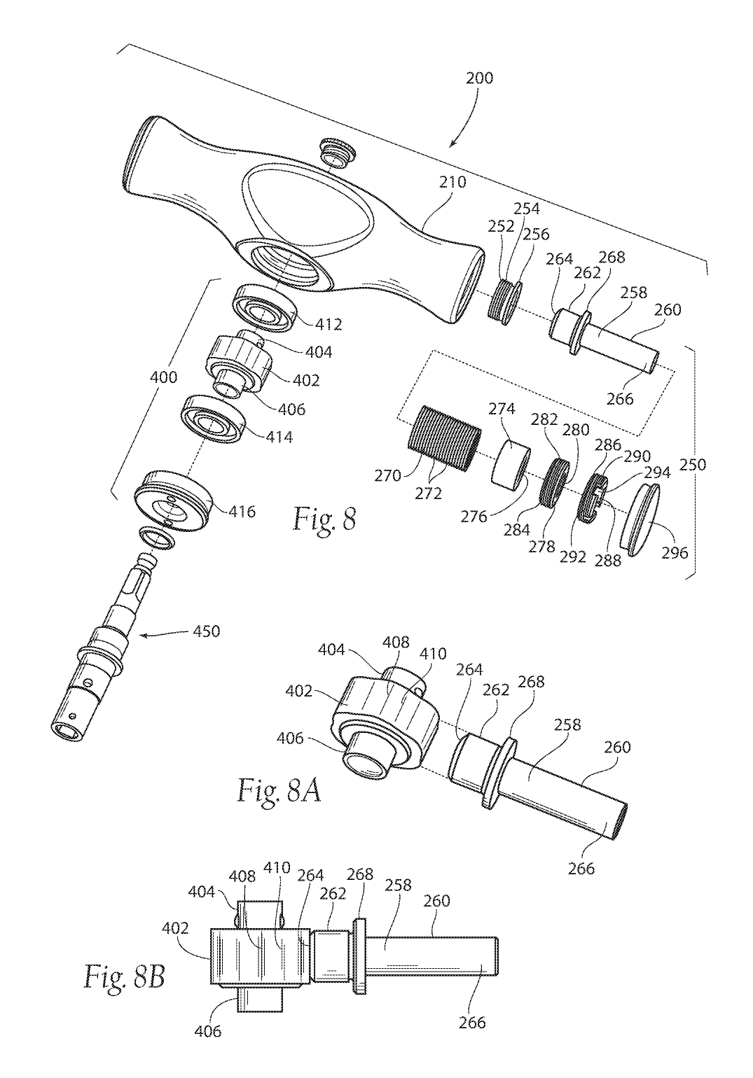

As most easily visible in FIG. 8 (but also shown in FIGS. 6 and 7), the first torque-limiting assembly 250 is depicted in an exploded view. The first torque-limiting assembly 250 preferably comprises a first sleeve 252, a first drive element 258, a first biasing mechanism 270, a first spacer 274, a first adjustment member 278, a first locking member 286, and a first cap 296. The second torque-limiting assembly 350 (shown in FIGS. 6 and 7) comprises the same elements as the first torque-assembly 250 (i.e., a second sleeve 352, a second drive element 358, a second biasing mechanism 370, a second spacer 374, a second adjustment member 378, a second locking member 386, and a second cap 396) and operates in the same manner. Therefore, in the interest of efficiency, the description of the first and second torque-adjustment assemblies 250,350 will be limited to only that of the first torque-adjustment assembly 250, although like numbers are provided in the Figures to indicate the like parts of the second torque-adjustment assembly 350.

The first sleeve 252 of the first torque-adjustment assembly 250 preferably has external threads 254 substantially along the entire first sleeve 252 and a collar 256.

The first spacer 274 has an aperture 276 and is configured to be movable within the first end portion channel 214 of the housing 210.

The first drive element 258 preferably comprises an elongate body 260 having a first end portion 262 configured to fit within the first sleeve 252, a second end portion 266 configured to fit within the aperture 276 of the first spacer 274, and a flange 268 extending radially outward from the body 260 of the first drive element 258 between the first end portion 262 and the second end portion 266. The first end portion 262 of the first drive element 258 has a rounded protrusion that characterizes the previously described embodied roller 264 extending from the first end portion 262.

The first biasing mechanism 270 preferably comprises a plurality of disc springs 272, or “Belleville washers.” The first biasing mechanism 270 is positioned on the body 260 of the drive element 258 between the first flange 268 and the first spacer 274.

The first adjustment member 278 preferably comprises an aperture 280 sized and configured to receive an end of a key tool (not shown) and has threads 284 about its outer periphery 282. Although a key shaped aperture is preferred, other tool interfaces are contemplated.

The first locking member 286 preferably comprises an aperture 288 and has threads 292 about its outer periphery 290. The first locking member 286 preferably has a plurality of notches 294 extending from the outer periphery 290 to the aperture 288.

The first cap 296 is preferably sized and configured to mate with the first end portion 212 of the housing 210 to cover the other parts of the first torque-limiting assembly 250 and cap the first end portion channel 214.

The driven assembly 400 preferably comprises a cam element 402, a first bearing 412, a second bearing 414, and a stop 416. The driven assembly is preferably configured to receive a shaft assembly 450.

The cam element 402 preferably has a first projection 404 and a second projection 406 extending axially in opposing directions, and a plurality of lobes 408, each spaced apart by a valley 410 with the lobes 408 and valleys 410 comprising the surface profile of the cam element 402. In the preferred embodiment, the cam element 402 has six evenly spaced lobes 408; however, the cam element 402 may have more or less than six lobes 408 and still be within the purview of the present invention.

The first and second bearings 412,414 are sized and configured to receive the first and second projections 404, 406, respectively and to be received within the medial portion channel 226 of the housing 210.

The stop 416 is preferably sized and configured to be received within the medial portion channel 226 of the housing 210, to retain the other elements of the driven assembly 400 within the medial portion channel 226, and allow access for the cam element 402 to receive the shaft assembly 450, as shown in FIGS. 6-8, preferably with the interfacing threads arranged to interact with the medial portion of channel 226 in a sufficient manner.

Looking to FIGS. 6 and 7, the interworking relationships of the first and second torque-limiting assemblies 250,350, the driven assembly 400, and the housing 210 (see also FIG. 12) are shown. The driven assembly 400 is received within the medial portion channel 226 of the housing 210, wherein the cam element 402 is positioned in radial alignment with the first and second end portion channels 214,230, the first and second bearings 412,414 are in contact with surrounding portions of the housing 210, and the stop 416 is secured to the housing 210 to retain the other elements of the driven assembly 400 within the medial portion channel 226.

The first torque-limiting assembly 250 is received within the first end portion channel 214. The threads 254 of the first sleeve 252 interface with the internal threads 222 of the proximal portion 220 of the first end portion channel 214. The collar 256 of the first sleeve 252 prevents the first sleeve 252 from being inserted into the medial portion channel 226 as it will first seat against a portion of the housing 210.

The first end portion 262 of the first drive element 258 is received within the first sleeve 252; the first biasing mechanism 270 is positioned about the elongate body 260 of the first drive element 258; and the second end portion 266 is received within the aperture 276 of the first spacer 274, whereby the first biasing mechanism 270 is positioned between the flange 268 of the first drive element 258 and the first spacer 274, and the rounded protrusion which makes up the embodied roller 264 is in direct contact with the cam element 402.

According to the present invention, no free gap is provided; the rounded protrusion 264 maintains direct contact with the cam element 402 under a pre-load during all phases of assembly and operation.

The relationship of the first end portion 262 of the first drive element 258 within the first sleeve 252 and the second end portion 266 within the first spacer 274 maintains a proper alignment of the rounded protrusion 264 with respect to the cam element 402 to better follow the lobes 408 and valleys 410 which make up the surface profile of the cam element 402.

The first adjustment member 278 is threaded into the first end portion channel 214 and seats against the first spacer 274. The amount of torque required to move the rounded protrusion 264 of the first drive element 258 out of a valley 410 of the cam element 402 when the torque-limiting driver 200 experiences applied torque is determined by the amount of spring force directed from the first biasing mechanism 270 to the first drive element 258. The spring force may be increased or decreased by moving the first spacer 247 closer to or farther from the cam element 402 as this will impart or relieve internal compression forces within the first biasing mechanism 270, respectively. Moving the first spacer 274 is accomplished by rotating the first adjustment member 278 within the first end portion channel 214 through the interaction of the first adjustment member threads 284 with the internal threads 218 of the distal portion 216 of the first end portion channel 214. A keyed tool (not shown) may be inserted into the aperture 280 of the first adjustment member 278 to provide a mechanical advantage when adjusting the torque-limiting setting.

The selected spring force is retained by the first locking member 286. The first locking member 286 is threaded into the first end portion channel 214 and is tightened against the first adjustment member 278, thereby preventing the first adjustment member 278 from rotating.

The first cap 296 is then attached to the housing 210 to cover the other elements of the first torque-limiting assembly 250.

The second torque-limiting assembly 350 is received within the second end portion channel 230 and interfaces with the cam element 402 just as the first torque-limiting assembly 250 is received within the first end portion channel 214 and interfaces with the cam element 402.

To further illustrate the unique arrangement of the present invention, FIGS. 8A and 8B show the interaction of the plunger 258 and the cam member 402. The plurality of lobes 408 and valleys 410 interact with the first end portion of the plunger 258 in a manner as discussed above, wherein an independent and separate bearing or bearings are not needed for the mechanisms to properly interact directly with one another. As will be appreciated with the further embodiments below, such a unique arrangement provides an improved cam mechanism compared to the prior art.

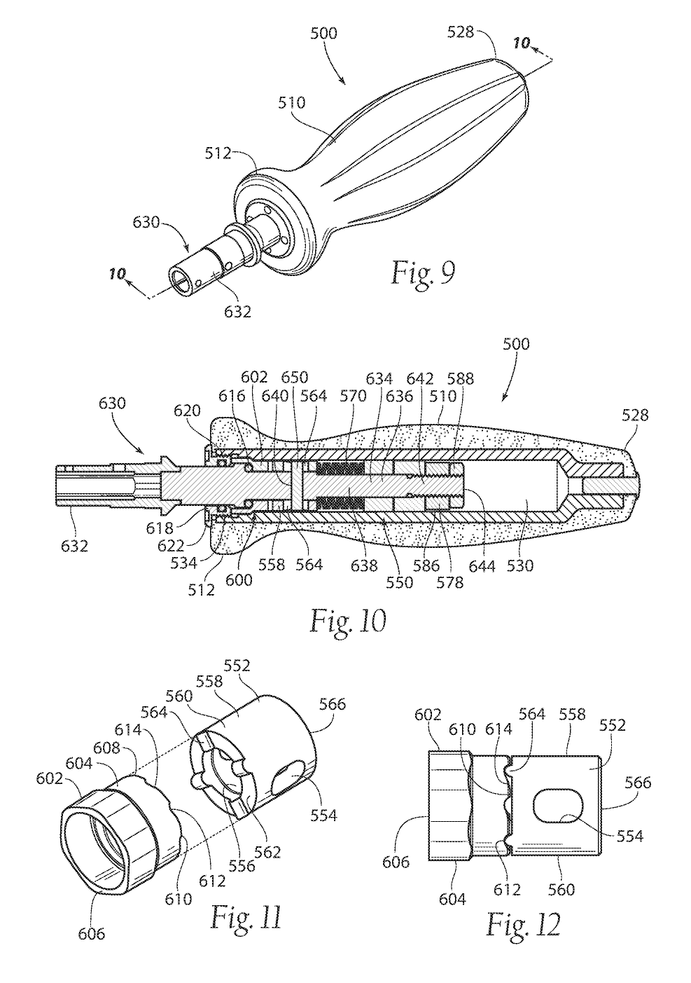

FIGS. 9-13 illustrate a second embodiment 500 of a torque-limiting handle according to the present invention. The torque-limiting handle 500 preferably comprises a handle housing 510, a torque-limiting assembly 550, a driven assembly 600, and a shaft assembly 630.

Looking at FIGS. 9, 10, and 13, the handle housing 510 comprises a first end portion 512, a second end portion 528, and a channel 530 extending from the first end portion 512 through the second end portion 528, with a threaded portion 534 provided in the channel 530 at the first end portion 512.

The shaft assembly 630 is also shown in FIGS. 9, 10, and 13. The shaft assembly 630 preferably comprises a first end portion 632 configured to receive a tool (not shown) and a second end portion 634 configured to be received within the channel 530 of the handle housing 510. The second end portion 634 of the shaft assembly 630 preferably comprises a shaft 636 with a proximal end portion 638 and a distal end portion 642. A through-hole 640 is preferably placed through the proximal end portion 638 of the shaft 636, perpendicular to the major dimension of the shaft 636. The distal portion 642 preferably has a threaded section 644.

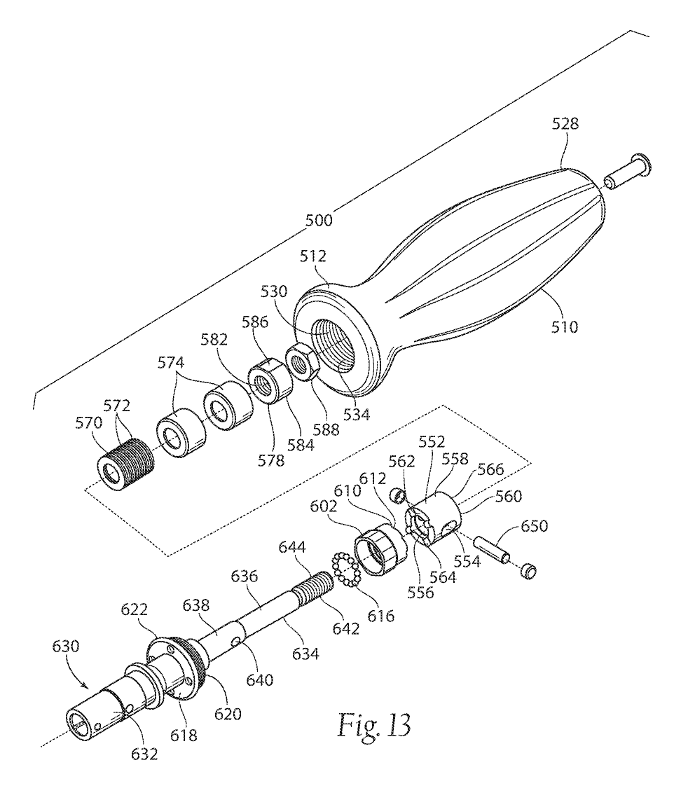

The torque-limiting assembly 550 can be seen in FIGS. 10 and 13. Preferably, the torque-limiting assembly 550 comprises a drive element 558, a biasing mechanism 570, at least one spacer 574, an adjustment member 578, and a locking member 586.

The drive element 558 preferably comprises a tubular body 560 with a first surface 562, a second surface 566, an outer periphery 552, and an inner periphery 556. A pair of apertures 554, preferably in the shape of oblong circles or slots, are located on the body 560 directly across from one another and extend from the outer periphery 552 through the inner periphery 556. The drive element 558 is configured to be received within the channel 530 of the handle housing 510 and to be received upon the shaft 636 of the shaft assembly 630 with the apertures 554 of the drive element 558 alignable with the through-hole 640 of the shaft 636, through which a dowel 650 extends to link the drive element 558 to the shaft 636 of the shaft assembly 630. A plurality of rounded protrusions 564 which comprise the embodied roller extend outward from the first surface 562 of the drive element 558 and are preferably spaced equidistant from each other about the first surface 562. In the preferred embodiment, the drive element 558 has four evenly spaced rounded protrusions 564; however, the drive element 558 may have more or less than four protrusions 564 and still be within the purview of the present invention.

Similar to the biasing mechanisms 270,370 of the first embodiment 200, the biasing mechanism 570 of the second embodiment 500, preferably comprises a plurality of disc springs 572, or “Belleville washers.” The biasing mechanism 570 is positioned on the shaft 636 of the shaft assembly 630 between the drive element 558 (adjacent to the second surface of the drive element 566) and at least one spacer 574 which is also positioned upon the shaft 636.

The adjustment member 578 is preferably tubular with a threaded inner periphery 582 and a pair of opposed flat surfaces 586 on its outer periphery 584 to aid when adjusting the adjustment member 578; however, alternative adjustment interfaces are contemplated. The adjustment member 578 is configured to be received upon and, engaged with, the threaded section 644 of shaft 636 of the shaft assembly 630 through the threaded inner periphery 582 on the adjustment member 578 and seating against at least one spacer 574. The adjustment member 578 may be rotated about the shaft 636 to increase or decrease the pre-load (or torque-limit setting) induced by the biasing mechanism 570 to the drive element 558 by moving the adjustment member 578 closer to or farther away from the drive element 558, respectively.

The locking member 588 is preferably a keyed nut received upon the threaded section 644 of the shaft 636 of the shaft assembly 630 which tightly seats against the adjustment member 578 to maintain the pre-load setting.

The drive assembly 600 preferably comprises a cam element 602, a stop 618, and a plurality of ball bearings 616. The cam element 602 has a tubular body 604 having a first surface 606 opposite a second surface 608. The second surface 608 preferably has a plurality of lobes 610 and valleys 612 in a repeated pattern of compound curves 614 which make up the surface profile of the cam element 602. The cam element 602 is configured to be received upon the proximal portion 638 of the shaft 636 of the shaft assembly 630 with its second surface 608 parallel to the first surface 562 of the drive element 558. The relationship between the second surface 608 of the cam element 602 and the first surface 562 of the drive element 558 can be seen further in FIGS. 11 and 12 and, preferably, do not touch. The ball bearings 616 are preferably used as the interface between the cam element 602 and the shaft assembly 630.

The cam element 602 is retained in position within the handle housing by the stop 618. The stop 618 is received upon the shaft 636 of the shaft assembly 630 and has a threaded section 620 and a lip section 622. The stop 618 contacts the first surface 606 of the cam element 602 at or near the threaded section 620, with the threaded section 620 interfacing with the threaded portion 534 of the channel 530 of the handle housing 510. The lip section 622 tightens against the outside of the handle housing 510 to secure the stop 618 in place. The arrangement of the cam element 602 to be seated or abut the inner surface of the shaft 636, e.g. the cam element being positioned within a mating surface within the inner surface of the shaft 636 in a manner wherein the mating surfaces allows for a transfer of applied torque.

In operation, when a torque is applied that exceeds the predetermined torque-limit, the handle housing 510 and cam element will rotate about the shaft assembly 630 to prevent applied torque above the predetermined torque limit from being transferred to the shaft assembly 630. When the applied torque above the predetermined torque limit is delivered, the biasing force of the biasing mechanism 570 will be overcome. The cam element 602 will continue to rotate with the handle housing 510 because of its positively linked relationship through the handle housing 510. As this occurs, the plurality of rounded protrusions 564 of the drive element 558 will follow the surface profile of the cam element 602 which is comprised of the plurality of lobes 610, plurality of valleys 612, and compound curves 614. The relative movement of the drive element 558 is rotational with respect to the cam element 602 but linear with respect to the handle housing 510. The drive element 558 is able to move linearly within the handle housing 510 because the dowel 650, which links the drive element 558 to the shaft assembly 630, is able to move linearly within the oblong circular apertures 554 of the drive element 558.

As discussed above in FIG. 8B, FIGS. 11 and 12 demonstrates the advantages and unique arrangement of the present invention. FIGS. 11 and 12 also show the interaction of the drive element 558 and the cam element 602 in the same fashion as the plunger 258 and the cam member 402 in FIG. 8A. The plurality of compound curves 614 and valleys 612 interact with the first end portion of the drive element 558 in a manner as discussed above, wherein an independent and separate bearing or bearings are not needed for the mechanisms to properly interact directly with one another.

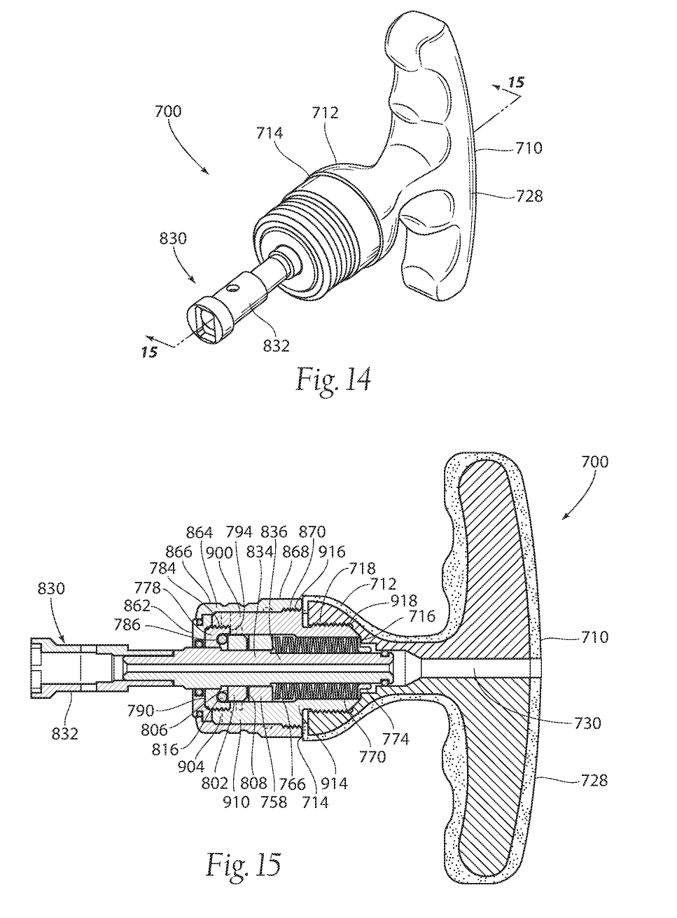

A third embodiment 700 of a torque-limiting handle according to the present invention is shown in FIGS. 14-18. The torque-limiting handle 700 preferably comprises a handle housing 710, a torque limiting assembly 750, a driven assembly 800, a shaft assembly 830, and a cover 860.

The handle housing 710 is shown in FIGS. 14, 15, and 18, which is a standard shaped handle. The handle housing 710 further includes a shaft assembly 830, which preferably comprises a first end portion 832 configured to receive a tool (not shown) and a second end portion 834 configured to be received within the channel 730 of the handle housing 710. The second end portion 834 preferably comprises a shaft 836 with a through-hole 840 (see FIG. 18) preferably placed through the shaft 836 and perpendicular to the major dimension of the shaft 836.

The torque-limiting assembly 750 preferably comprises a drive mechanism 758, a case 900, a biasing mechanism 770, a spacer 774, an adjustment member 778, and a plurality of set screws 788.

The case 900, visible in FIGS. 15 and 18, preferably comprises a tubular body 902 with a first section 904, a second section 914, a middle section 910 between the first section 904 and the second section 914, an outer periphery 920, and an inner periphery 922. The middle section 910 has a pair of opposed apertures 912 directly across from each other, preferably shaped like oblong circles or slots, extending from the outer periphery 920 through the inner periphery 922. The first section 904 has a threaded portion 906 along the inner periphery 922 and a plurality of threaded set screw holes 908 extending from the outer periphery 920 through the inner periphery 922. The second section 914 has a first tier threaded portion 916 and a second tier threaded portion 918 on the outer periphery 920, with the first tier threaded portion 916 configured to be engageable with the threaded portion 718 of the handle housing 710.

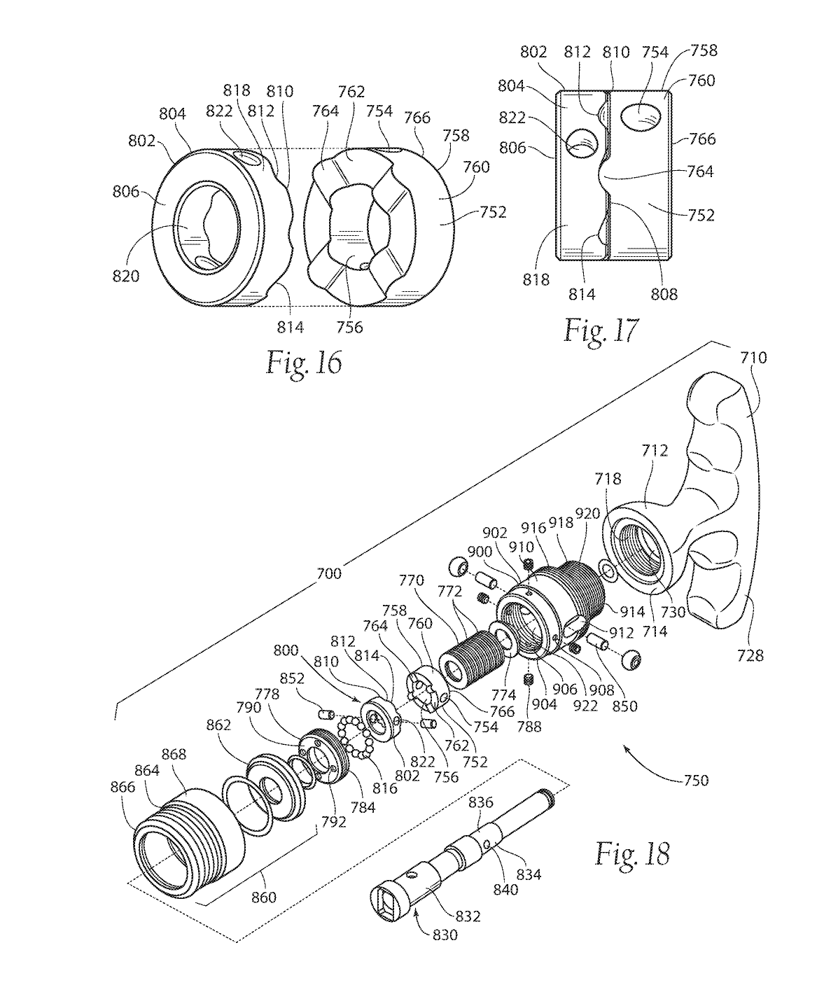

The drive element 758 (see also FIGS. 16 and 17) preferably comprises a tubular body 760 with a first surface 762, a second surface 766, an outer periphery 752, and an inner periphery 756. A pair of apertures 754 located on the body 760 directly across from one another and extend from the outer periphery 752 through the inner periphery 756. The drive element 758 is configured to be received within the case 900 and to be received upon the shaft 836 of the shaft assembly 830 with the apertures 754 of the drive element 758 aligned with the apertures 912 of the case 900, in which a dowel 850 extends through each aligned set of apertures 754,912 to link the drive element 758 to the case 900. A plurality of rounded protrusions 764 which comprise the embodied roller extend outward from the first surface 762 of the drive element 758 and are preferably spaced equidistant from each other about the first surface 762. In the preferred embodiment, the drive element 758 has four evenly spaced rounded protrusions 764; however, the drive element 758 may have more or less than four protrusions 764 and still be within the purview of the present invention.

As discussed above (FIGS. 8B, 11 and 12), FIGS. 16 and 17 further show the advantages and unique arrangement of the present invention. The cam member 802 and the plurality of lobe and valleys 812 are designed to interact with the drive element 758, wherein an independent and separate bearing or bearings are not needed for the mechanisms to properly interact directly with one another.

Referring again to FIGS. 15 and 18, to the biasing mechanisms 270,370,570 of the first and second embodiments 200,500 the biasing mechanism 770 of the third embodiment 700, preferably comprises a plurality of disc springs 772, or “Belleville washers.” The biasing mechanism 770 is positioned on the shaft 836 of the shaft assembly 830 between the drive element 758 (adjacent to the second surface 766 of the drive element 758) and the spacer 774 which is also received upon the shaft 836 of the shaft assembly 830.

The adjustment member 778 is preferably tubular with a first surface 790, a second surface 794, a threaded outer periphery 784, and a ball bearing race 786 (see FIG. 15) extending from the second surface 794 towards the first surface 790. The threaded outer periphery 784 interfaces with the threaded portion 906 of the first section 904 of the case 900. The first surface 790 preferably has a plurality of engagement features, here shown as cavities 792 (see FIG. 18), to be engaged by a tool (not shown) for setting the pre-determined torque-limit. The adjustment member 778 may be rotated within the case 900 to increase or decrease the pre-load (or torque-limit) induced by the biasing mechanism 770 to the drive mechanism 758 by moving the adjustment member 778 closer to or farther away from the drive element 758, respectively.

To lock the adjustment member 778 at a predetermined torque-limit setting, the plurality of set screws 788 are screwed into the plurality of threaded set screw holes 908 in the case 900 and into the outer periphery 784 of the adjustment member 778.

The drive assembly 800 comprises a cam element 802 (see also FIGS. 16 and 17) and a plurality of ball bearings 816. The cam element 802 has a tubular body 804 having a first surface 806 opposite a second surface 808, an outer periphery 818, an inner periphery 820, and a pair of apertures 822 opposite each other extending from the outer periphery 818 through the inner periphery 820. The second surface 808 preferably has a plurality of lobes 810 and valleys 812. In a repeated pattern of compound curves 814 which make up the surface profile of the cam element 802. The cam element 802 is configured to be received upon the shaft 836 of the shaft assembly 830 with its second surface 808 parallel to the first surface 762 of the drive element 758. The relationship between the second surface 808 of the cam element 802 and the first surface 762 of the drive element 758 can be seen further in FIGS. 16 and 17 and, preferably, do not touch. The plurality of ball bearings 816 are placed within the ball bearing race 786 of the adjustment member 778 and contact the first surface 806 of the cam element 802.

The cam element 802 is preferably directly linked to the shaft assembly 830 through a pair of dowels 852 placed through the pair of apertures 822 in the cam element 802 and into the through-hole 840 on the shaft 836 of the shaft assembly 830.

The cover 860 shown here comprises a cap 862 and a sleeve 864. The cap 862 closes a first end portion 866 of the sleeve 864 and a second end portion 868 of the sleeve has threads 870 which engage with the second tier threaded portion 918 of the case 900.

In operation, when a torque is applied that exceeds the predetermined torque-limit, the handle housing 710 will rotate with the torque-limiting assembly 750 relative to the driven assembly 800 and the shaft assembly 830 to prevent applied torque above the predetermined torque limit from being transferred to the shaft assembly 830. When the applied torque above the predetermined torque limit is delivered, the biasing mechanism 770 will be overcome. The drive element 758 will continue to rotate with the handle housing 710 because of its positively linked relationship with the case 900 through the dowels 850. As this occurs, the plurality of rounded protrusions 764 of the drive mechanism 758 will follow the surface profile of the cam element 802 which is comprised of the plurality of lobes 810, plurality of valleys 812, and compound curves 814. The relative movement of the drive element 758 is rotational with respect to the cam element 802 but linear with respect to the case 900 and the handle housing 710. The drive element 758 is able to move linearly within the case 900 because the dowels 850 are able to move linearly within the oblong circular apertures 912 in the case 900.

The foregoing is considered as illustrative only of the principles of the invention. Furthermore, since numerous modifications and changes will readily occur to those skilled in the art, it is not desired to limit the invention to the exact construction and operation shown and described. While the preferred embodiments have been described, the details may be changed without departing from the invention, which is defined by the claims.

We claim:

1. A torque-limiting driver comprising:
a handle housing having at least one channel;
at least one torque-limiting assembly located at least partially within the at least one channel, the at least one torque-limiting assembly comprising:
a drive element having at least one rounded protrusion that comprises an embodied roller;
a biasing mechanism positioned adjacent to the at least one drive mechanism configured to apply a biasing force to the drive mechanism;
an adjustment member operatively connected to the biasing mechanism; and
a locking member operatively connected to the adjustment member;
a driven assembly comprising a cam element with a surface with at least one set of alternating lobes and valleys along a repeated pattern of compound curves that comprise the surface profile of the cam element; and
wherein the at least one rounded protrusion of the drive element maintains constant direct contact with the surface profile of the cam element through a preload from the biasing mechanism set by the adjustment member, thereby providing a torque limiting function.

2. The torque-limiting driver according to claim 1, wherein the adjustment member is able to be adjusted to vary the torque limiting setting.

3. The torque-limiting driver according to claim 1, wherein the at least one torque-limiting assembly is perpendicular to the driven assembly.

4. The torque-limiting driver according to claim 1, wherein the at least one torque-limiting assembly is axially aligned with the driven assembly.

5. The torque-limiting driver according to claim 1, wherein the biasing mechanism comprises a plurality of disc springs.

6. The torque-limiting driver according to claim 1, further comprising:
a shaft assembly with a shaft having a through-hole;
a dowel;
the drive element further comprising a tubular body with a pair of opposing oblong apertures and is positioned upon the shaft; and
wherein the drive element is coupled to the shaft by the dowel inserted through the oblong apertures of the drive element and into the through-hole of the shaft allowing linear motion of the drive element along the shaft.

7. The torque-limiting driver according to claim 1, further comprising:
a case engaged with the handle housing, wherein the case comprises a pair of opposed oblong apertures;
a pair of dowels;
the drive element further comprising a tubular body with a pair of opposing apertures and is positioned within the case; and
wherein the drive element is coupled to the case by the dowels inserted through the oblong apertures of the case and into the apertures of the drive element.

8. A torque-limiting driver for a tool, said drive comprising:
a housing;
a driven assembly located within said housing, said driven assembly comprising:
a cam element having a surface with continuous repeating alternating lobes and valleys;
at least one drive element having a first end portion with a rounded protrusion and a second end, said first end portion in constant direct contact with the cam element;
means for supplying biasing force to said driven assembly; and
means for connecting said driven assembly to said tool.

9. The torque-limiting drive according to claim 8, further comprising:
a second drive element having a first end portion with a rounded protrusion and a second end, said first end portion in constant direct contact with the cam element.

10. The torque limiting drive according to claim 8, wherein said means for supplying said biasing force to said driven assembly is adjustable.

11. The torque limiting drive according to claim 8, further comprising a locking member for controlling said biasing force when adjusted.

12. A torque-limiting driver comprising:
a housing having a first end portion with a first end portion chamber, a second end portion with a second end portion chamber, and a medial portion between the first end portion and the second end portion having a medial portion chamber;
a first torque-limiting assembly located in the first end portion chamber comprising:
a first sleeve;
a first spacer;
a first drive element having an elongate body with a first end portion with a rounded protrusion comprising the embodied roller, a second end portion, and a flange;
a first adjustment member adjacent to the first spacer; and
a first locking member adjacent to the first adjustment member;
the second end portion of the first drive element extending through the first spacer; and
a first biasing mechanism positioned around the body of the first drive element between the flange and the first spacer configured to apply a biasing force to the first drive element;
a second torque-limiting assembly located in the second end portion chamber comprising:
a second sleeve;
a second spacer;
a second drive element having an elongate body with a first end portion with a rounded protrusion comprising the embodied roller, a second end portion, and a flange;
a second adjustment member adjacent to the second spacer; and
a second locking member adjacent to the second adjustment member;
the second end portion of the second drive element extending into the second spacer; and
a second biasing mechanism positioned around the body of the second drive element between the flange and the second spacer configured to apply a biasing force to the second drive element;
a driven assembly comprising a cam element with alternating lobes and valleys along a repeated pattern of compound curves that comprise the surface profile of the cam element located in the medial portion chamber; and
wherein the rounded protrusion of the first drive element and the rounded protrusion of the second drive element are configured to be oppositely disposed and in constant direct contact with the cam element by the biasing forces provided by the respective first and second biasing mechanisms.

13. The torque-limiting driver according to claim 12, wherein
the first end portion chamber has a distal portion with internal threads;
the second end portion chamber has a distal end with internal threads;
the first adjustment member has an outer periphery with threads configured to interface with the threads of the distal portion of the first end portion chamber;
the second adjustment member has an outer periphery with threads configured to interface with the threads of the distal portion of the second end portion chamber;
whereby the biasing force applied to the first drive element by the first biasing mechanism is able to be adjusted by turning the first adjustment member into or out of the first end portion chamber; and
whereby the biasing force applied to the second drive element by the second biasing mechanism is able to be adjusted by turning the second adjustment member into or out of the second end portion chamber.

14. The torque-limiting driver according to claim 13, wherein
the first locking member has an outer periphery with threads configured to interface with the threads of the distal portion of the first end portion chamber;
the second locking member has an outer periphery with threads configured to interface with the threads of the distal portion of the second end portion chamber;
whereby the first adjustment member is retained in a predetermined position by seating the first locking member against the first adjustment member; and
whereby the second adjustment member is retained in a predetermined position by seating the second locking member against the second adjustment member.

15. The torque-limiting driver according to claim 13, wherein the first adjustment member has an aperture and the second adjustment member has an aperture, wherein the apertures of the first and second adjustment members are shaped to receive a key tool.
